(19) United States
(12) Patent Application Publication
(10) Pub. No.: US 2021/0015084 A1
(43) Pub. Date: Jan. 21, 2021

(54) LIVE BAIT RIG

(71) Applicant: Elbert Harris, III, San Francisco, CA (US)

(72) Inventor: Elbert Harris, III, San Francisco, CA (US)

(21) Appl. No.: 16/512,853

(22) Filed: Jul. 16, 2019

(51) Int. Cl. A01K 97/02; A01K 83/06

(52) U.S. Cl. CPC A01K 97/02; A01K 83/06

(57) ABSTRACT

A method and apparatus for a fishing bait line for fishing is presented. The fishing bait line having a main line. The main line has a first end, a second end and a middle portion. A first barrel swivel is coupled to the first end of the main line. A clip swivel is coupled to the second end of the main line. A second barrel swivel is coupled to the middle portion of the main line. One or more glow in the dark beads are coupled substantially near the middle portion of the main line. A glow in the dark chum cylinder coupled to middle portion of the main line. A sponge inserted into the glow in the dark chum cylinder. A hook line threaded through a second end of the glow in the dark chum cylinder and threaded through the sponge. The hook line is coupled to the second barrel swivel. The hook line has a hook for fishing.

### FIELD OF THE INVENTION

This invention relates to fishing. More particularly, it relates to live bait used in fishing.

### BACKGROUND

Fishing is the activity of trying to catch fish. Fish are normally caught in the wild. Techniques for catching fish include hand gathering, spearing, netting, angling and trapping. “Fishing” may include catching aquatic animals other than fish, such as mollusks', cephalopods, crustaceans, and echinoderms. The term is not normally applied to catching farmed fish, or to aquatic mammals, such as whales where the term whaling is more appropriate. In addition to being caught to be eaten, fish are caught as recreational pastimes. Fishing tournaments are held, and caught fish are sometimes kept as preserved or living trophies. When bio blitzes occur, fish are typically caught, identified, and then released.

Fishing bait is any substance used to attract and catch fish, e.g. on the end of a fishing hook, or inside a fish trap. Traditionally, nightcrawlers, insects, and smaller bait fish have been used for this purpose. Fishermen have also begun using plastic bait and more recently, electronic lures, to attract fish.

Studies show that natural baits like croaker and shrimp are more recognized by the fish and are more readily accepted. Which of the various techniques a fisher may choose is dictated mainly by the target species and by its habitat. Bait can be separated into two main categories: artificial baits and natural baits.

The natural bait angler, with few exceptions, will use a common prey species of the fish as an attractant. The natural bait used may be alive or dead. Common natural baits include worms, leeches notably bait-leech, minnows, frogs, salamanders, and insects. Natural baits are effective due to the lifelike texture, odor and color of the bait presented. Cheese has been known to be a very successful bait due to its strong smell and light colors.

The common earthworm is a universal bait for fresh water angling. Grubs and maggots are also excellent bait when trout fishing. Grasshoppers, bees and even ants are also used as bait for trout in their season, although many anglers believe that trout or salmon and many other fresh water fish roe is superior to any other bait. In some lakes, fish such as bream will take bread bait. Bread bait is a small amount of bread, often moistened by saliva, balled up to a small size that is bite size to a small fish.

Most common earthworm species which can often be dug up in the garden, are eminently suitable for freshwater fishing. However, on a commercial scale they are not really candidates for worm farming for providing fishing bait. The greyish brown common earthworms are deep burrowing and do not readily breed in the shallow worm farm bins. The red compost worms, such as the well-known red wiggler or the European nightcrawler, are better candidates, as they are epigeal, or surface dwellers. This is the reason that red worms are more usually available commercially for bait worms. Their natural home is just below the surface in rotting leaves, dung heaps and other plant litter. They are called detritivourous because they eat detritus (waste material).

The larger species, the European nightcrawler is much sought after for fishing bait as it tolerates near freezing water and is one of the few earthworms suitable for salt-water fishing. These worms can grow up to 7 inches (18 cm) in length, but usually are between 3 and 4 inches (7-10 cm) long. Worm farmers also offer other worm species for bait, depending on availability, which usually depends on the prevalent climatic conditions.

Fishing lines are hard to see in the dark and do not attract fish easily. Further, when bait dies or becomes old, the bait may go to the bottom of the fishing area where crabs and other sea creatures may eat the bait. The present application presents a solution for these and other deficiencies of the current fishing products.

### BRIEF DESCRIPTION OF THE DRAWINGS

FIG. 1 is an illustrated view of an exemplary fishing bait line.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

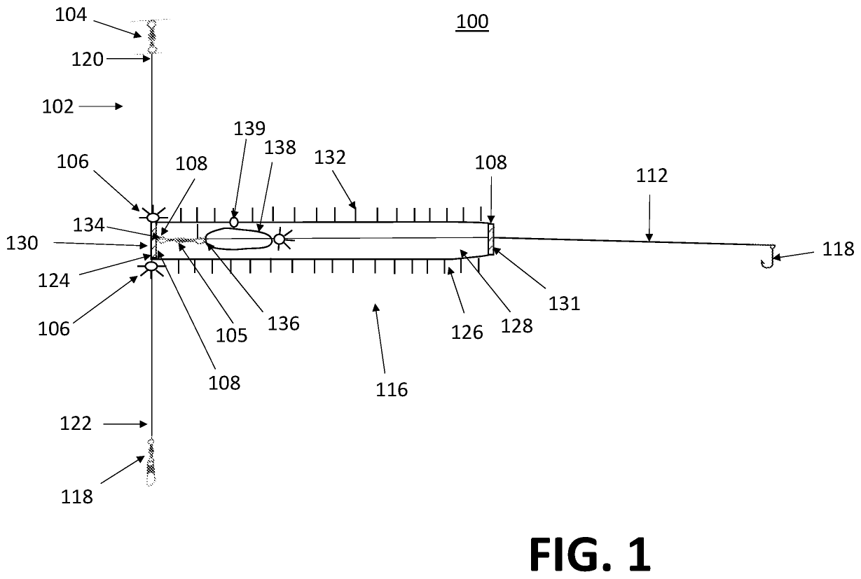

Referring to FIG. 1, an illustrated view of an exemplary fishing bait line 100 for catching fish is presented. The fishing bait line 100 is useful for when live bait attached to the hook die or get old, then the fishing bait line 100 prevents the live bait from going to the bottom and getting eaten by crabs, etc. that feed off the bait when it gets to the bottom.

The fish bait line 100 is preferably twenty-four (24) inches in length but other lengths are contemplated to meet the needs of an angler, such as, but not limited to, twenty (20) inches, forty (40) inches, etc.

The fish bait line 100 is preferably twenty-four (24) inches in height but other heights are contemplated to meet the needs of an angler, such as, but not limited to, twenty (20) inches, forty (40) inches, etc.

The fish bait line 100 is preferably ten (10) inches in width but other widths are contemplated to meet the needs of an angler, such as, but not limited to, five (5) inches, twelve (12) inches, etc.

The fishing bait line 100 has a main line 102, one or more-barrel swivels 104, 105, one or more glow in the dark beads 106, one or more chum screens 108, a chum sponge 110, a hook line 112, a hook 114, a glow in the dark chum cylinder 116 and a clip swivel 118.

The main line 102 of the fishing bait line 100 has a first end 120, a second end 122 and a middle portion 124. The main line 102 is preferably twenty-four (24) inches in length but other lengths are contemplated such as, but not limited to, thirty (30) inches, fifteen (15) inches, etc.

One of the barrel swivels 104 is coupled to the first end 120 of the main line 102 of the fishing bait line 100. The clip swivel 118 is coupled to the second end 122 of the main line 102 of the fishing bait line 100.

The one or more glow in the dark beads 106 are coupled significantly near the middle portion 124 of the main line 102 of the fishing bait line 100. The one or more glow in the dark beads 106 when glowing is attractive to the fish and may be helpful in luring the fish to the fishing bait line 100. The glow in the dark chum cylinder 116 and the one or more glow in the dark beads 106 are necessary when fishing at night, in murky water, or in deep sea fishing.

The glow in the dark chum cylinder 116 has an outside 126, an inside 128, a first end 130 and a second end 131. One of the chum filters 108 is coupled to the first end 130 of the glow in the dark chum cylinder 116. A second of the chum filters 108 is coupled to the second end 131 of the glow in the dark chum cylinder 116.

The first end 130 of the glow in the dark chum cylinder 116 is coupled significantly near the middle portion 124 of the main line 102. The one or more glow in the dark beads 106 coupled to the main line 102 are significantly near the first end 130 of the glow in the dark chum cylinder 116.

The outside 126 of the glow in the dark chum cylinder 116 may have nubs 132 where the nubs 132 may have movement to immolate live bait to attract fish. The nubs 132 are preferably made of a rubber material but other materials are contemplated such as, but not limited to, soft plastic, nylon, etc.

The inside 124 of the glow in the dark chum cylinder 116 has one of the one or more-barrel swivels 104 where a first end 134 of the one or more-barrel swivels 105 is significantly near the first end 124 of the glow in the dark chum cylinder 116 and coupled significantly near the middle portion 124 of the main line 102.

A second end 136 of the one or more-barrel swivels 105 is coupled to a sponge 138. The sponge 138 is useful for keeping the live bait from reaching the bottom such that the bottom feeders such as crabs, etc. will not eat the bait.

A first end 142 of the hook line 112 is threaded through the second end 131 of the glow in the dark chum cylinder 116 and further threaded through the sponge 138 and coupled to a second end 140 of the one or more-barrel swivels 105.

A hole 139 in the glow in the dark cylinder 116 is necessary for providing access to impregnate the sponge 138 contained in the glow in the dark chum cylinder 116. The hole 139 in the glow in the dark cylinder 116 provides an opening which allows for a syringe to be used to provide the sponge with a small supply of chum material or liquid bait scent material.

A second end 144 of the hook line 112 is coupled to the hook 114. Live bait is coupled to the hook 114 such that when put into water with the fish, the fish may decide to eat the bait and be caught on the hook 114.

To use the fishing bait line 100, an angler would secure the barrel swivel 104 coupled to the first end 120 of the main line 102 to the angler's fishing line coupled to the anglers fishing rod and reel. The angler would then secure a weight to the clip swivel 118 coupled to the second end 122 of the main line 102.

The angler would then impregnate the sponge 128 with a small supply of chum material or a liquid bait scent material.

The angler then couples a desired bait to the hook 114 securely coupled to the hook line 112. The angler would next put the fishing bait line 100 into the water to fish.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fishing bait line for fishing, the bait line comprising:
a main line, the main line having a first end, a second end and a middle portion;
a first barrel swivel, the barrel swivel coupled to the first end of the main line;
a clip swivel, the clip swivel coupled to the second end of the main line;
a second barrel swivel coupled to the middle portion of the main line;
one or more glow in the dark beads, the one or more glow in the dark beads coupled substantially near the middle portion of the main line;
a glow in the dark chum cylinder coupled to middle portion of the main line;
a sponge inserted into the glow in the dark chum cylinder; and
a hook line, the hook line threaded through a second end of the glow in the dark chum cylinder and threaded through the sponge, wherein the hook line coupled to the second barrel swivel, and wherein the hook line having a hook for fishing. The system of claim 1, further comprising a remote control.

2. The bait line of claim 1, wherein bait line having a height of twenty-four (24) inches.

3. The bait line of claim 1, wherein bait line having a length of twenty-four (24) inches.

4. The bait line of claim 1, wherein bait line having a width of ten (10) inches.

5. The bait line of claim 1, wherein the sponge being impregnated with a bait scent liquid.

6. The bait line of claim 1, wherein the sponge being impregnated with a a chum material.

7. The bait line of claim 1, the glow in the dark chum cylinder further comprising one or more nubs.

8. The bait line of claim 1, wherein the glow in the dark beads being made of a glow material.

9. The bait line of claim 7, wherein the one or more nubs being made of a rubber material.

10. The bait line of claim 1, further comprising:
A first chum screen coupled to a first end of the glow in the dark chum cylinder; and
A second chum screen coupled to a second end of the glow in the dark chum cylinder.

11. A method of using a fishing bait line, the method comprising:
securing a barrel swivel to a first end of a main line;
securing a clip swivel to a second end of the main line;
impregnating a small supply of chum material to a sponge;
inserting the sponge into a glow in the dark chum cylinder;
threading a hook line through the glow in the dark chum cylinder and the sponge;
coupling a second barrel swivel to the main line and the hook line; and
securely coupling a hook to the hook line.

12. The method of claim 11, wherein bait line having a height of twenty-four (24) inches.

13. The method of claim 11, wherein bait line having a length of twenty-four (24) inches.

14. The method of claim 11, wherein bait line having a width of ten (10) inches.

15. The method of claim 11, further comprising coupling one or more nubs to an outside of the glow in the dark chum cylinder.

16. The method of claim 15, wherein the one or more nubs being made of a rubber material.

17. The method of claim 11, further comprising:
securely coupling a first chum screen to a first end of the glow in the dark chum cylinder; and
securely coupling a second chum screen coupled to a second end of the glow in the dark chum cylinder.
